(19) United States
(12) Patent Application Publication
(10) Pub. No.: US 2025/0001616 A1
(43) Pub. Date: Jan. 2, 2025

(54) SELECTIVE VISUAL APPEARANCE AND SOCIAL BEHAVIOR EXHIBITING FOR A HUMANOID IN A HUMAN AND HUMANOID COLLABORATION

(71) Applicant: International Business Machines Corporation, Armonk, NY (US)

(72) Inventor: Sarbajit K. Rakshit, Kolkata (IN)

(21) Appl. No.: 18/342,055

(22) Filed: Jun. 27, 2023

(51) Int. Cl. B25J 11/00; B25J 9/16; G06T 19/00

(52) U.S. Cl. CPC B25J 11/0015; B25J 9/163; B25J 11/001; G06T 19/006

(57) ABSTRACT

One or more systems, devices, computer program products and/or computer-implemented methods provided herein relate to human-humanoid robot interaction, and more specifically, to configuring an appearance and social behavior of a humanoid in a human-humanoid interaction. In an embodiment, the configuration is based on a human profile. In an embodiment, the human profile can be associated with a real human.

### BACKGROUND

The subject disclosure relates to computing systems, and more specifically, to configuring robots.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus and/or computer program products in accordance with the present invention.

According to an embodiment, a system can comprise a memory that stores computer executable components; and a processor that executes the computer executable components stored in the memory. The computer executable components can comprise: a visualization component that alters an appearance of a humanoid robot to imitate an appearance of a first human from the perspective of a second human; and a behavior component that adapts the appearance of the humanoid robot based on a human profile associated with the first human comprising information related to social interaction characteristics of interactions between the first human and the second human. Additional aspects of the present disclosure are directed to systems and computer program products configured to perform the methods described above.

### DESCRIPTION OF THE DRAWINGS

FIG. 1 illustrates a block diagram of an example, non-limiting system that can facilitate configuration of an appearance and social behavior of a humanoid, in accordance with one or more embodiments described herein.

FIG. 2 illustrates a block diagram of an example, non-limiting system that can facilitate configuration of an appearance and social behavior of a humanoid, in accordance with one or more embodiments described herein.

FIG. 3 illustrates a diagram of an example, non-limiting system that can facilitate configuration of an appearance and social behavior of a humanoid, in accordance with one or more embodiments described herein.

FIG. 4 illustrates a flow diagram of an example, non-limiting computer-implemented method in accordance with one or more embodiments described herein.

FIG. 5 illustrates a flow diagram of an example, non-limiting computer-implemented method in accordance with one or more embodiments described herein.

FIG. 6 illustrates a flow diagram of an example, non-limiting computer-implemented method in accordance with one or more embodiments described herein.

FIG. 7 illustrates a flow diagram of an example, non-limiting computer-implemented method in accordance with one or more embodiments described herein.

FIG. 8 illustrates a flow diagram of an example, non-limiting computer-implemented method in accordance with one or more embodiments described herein.

FIG. 9 illustrates a block diagram of an example, computing environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

Humanoid robots are currently in development for eventual collaboration with human workers. Humanoid robots can mimic human motions and interactions. For example, humanoid robots can walk, wave their arms, grip objects in their fingers, and converse with humans. Humanoid workers are expected to be able to perform activity in work environments, such as an industrial floor. Humanoid workers could help increase productivity and efficiency in some work environments. Humanoid workers will likely work in conjunction with human workers. Human workers are accustomed to working with other humans and are not accustomed to working with or interacting with humanoid robots. Social cohesion in the workplace may require that humanoid robots exhibit social interaction skills like those of humans. Human workers are likely to be more comfortable and exhibit higher levels of productivity and satisfaction if humanoid workers feel familiar to them.

One way that humanoid robots can feel more familiar to human workers is if they resemble humans rather than robots. In an embodiment, augmented reality technology can cause a humanoid robot to appear as a human from the perspective of another human. For example, a human worker can view a humanoid robot through an augmented reality glass. The augmented reality glass can alter the visual appearance of the humanoid robot to the human worker so that the humanoid robot appears to be a human. For example, the augmented reality glass or other visualization tool can cause the appearance of the humanoid robot to be an appearance of a particular human that is known to the human worker. For example, the humanoid robot can take on the appearance of a human coworker of the human worker from the perspective of the human worker.

In an embodiment, the human worker can select the appearance of the humanoid robot. For example, the human worker can make a selection indicating one of a plurality of the human worker's coworkers. The visualization tool can then alter the appearance of the humanoid robot so that the appearance resembles an appearance of the selected human worker.

In an embodiment, each of a plurality of available human appearance options, such as the plurality of the human worker's coworkers can be associated with a human profile. The human profile can comprise information relating to the appearance of a human, social interaction skills associated with a human, and mobility characteristics of a human.

In an embodiment, a humanoid robot can mimic social and other behaviors of a human. For example, a humanoid robot can appear to smile, make eye contact, and speak with hand gestures. In the case of physical movements such as hand gestures, the humanoid robot can mimic physical movements of a human as well. A human interacting with the humanoid robot can feel a sense of familiarity because from the human's perspective, the human appears to be interacting with another human who is exhibiting the social behaviors of that human.

By way of overview, aspects of systems apparatuses or processes in accordance with the present disclosure can be implemented as machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however in various cases, that the one or more embodiments can be practiced without these specific details. As used herein, the term “entity” can refer to a machine, device, component, hardware, software, smart device and/or human.

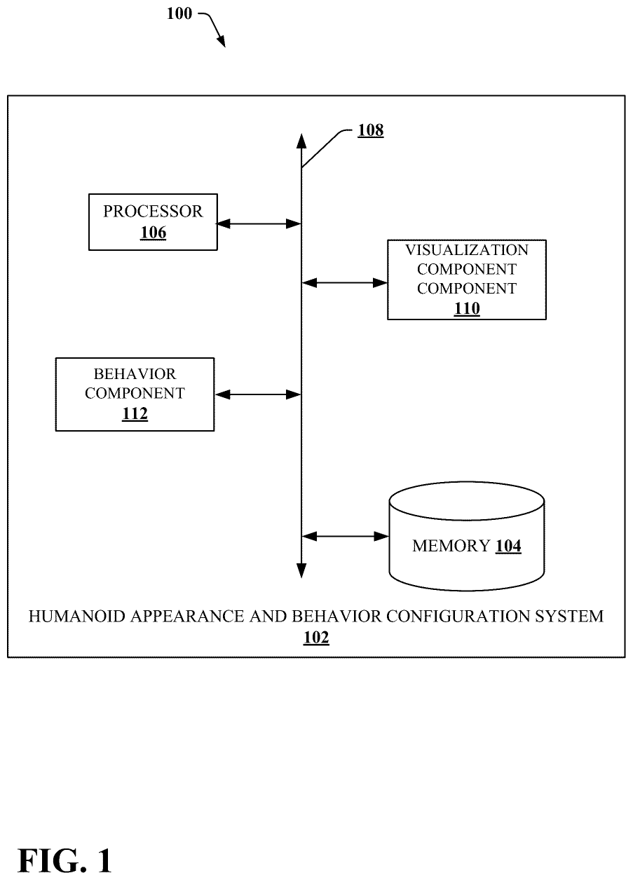

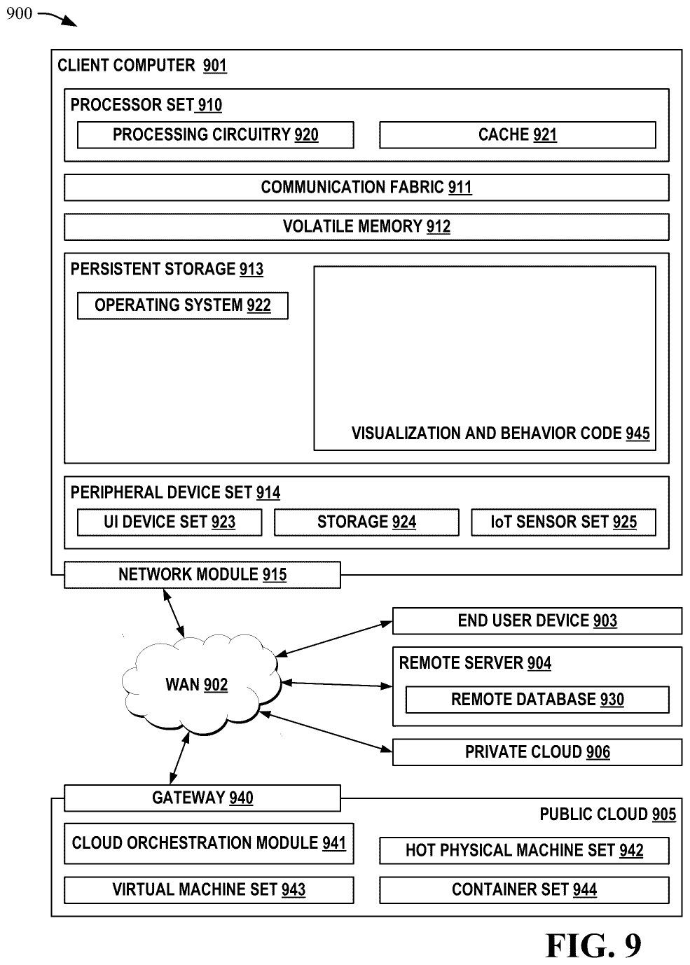

Further, the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting systems 100-300 as illustrated at FIGS. 1-3, and/or systems thereof, can further comprise, be associated with and/or be coupled to one or more computer and/or computing-based elements described herein with reference to an operating environment, such as the operating environment 900 illustrated at FIG. 9. In one or more described embodiments, computer and/or computing-based elements can be used in connection with implementing one or more of the systems, devices, components and/or computer-implemented operations shown and/or described in connection with FIGS. 1-3 and/or with other figures described herein.

FIG. 1 illustrates a block diagram of an example, non-limiting humanoid appearance and behavior configuration system 102 that facilitates configuration of an appearance and behavior of a humanoid robot for interaction with a human in accordance with one or more embodiments described herein. As illustrated at FIG. 1, the humanoid appearance and behavior configuration system 102 can comprise one or more components, such as a memory 104, processor 106, bus 108, visualization component 110 and/or behavior component 112. Generally, humanoid appearance and behavior configuration system 102 can facilitate configuration of an appearance and social behavior of a humanoid based on a human profile.

The visualization component 110 can alter an appearance of a humanoid robot to imitate an appearance of a first human from the perspective of a second human. For example, the second human could view the humanoid robot through an augmented reality glass. The visualization component 110 can cause the augmented reality glass to virtually convert the appearance of humanoid worker to an appearance of a human worker from the perspective of the second human. For example, the visualization component can cause an avatar of the first human to completely or partially overlay the appearance of a humanoid robot. In an embodiment, the humanoid robot can appear to the second human to be the first human. In an embodiment, the first human can be a person known to the second human, such as a coworker of the second human. In an embodiment, the visualization component 110 can convert the appearance of the humanoid robot to imitate an appearance of the first human based on a human profile associated with the first human. The human profile can comprise information relating to the physical appearance of the first human. For example, the human profile can comprise images and video footage of the first human. The information relating to the physical appearance of the first human can comprise information relating to the appearance of the first human in various social circumstances. For example, the human profile can comprise an image of the first human smiling, a video of the first human engaged in a conversation (speaking or listening), or images of the first human in various other social circumstances. In an embodiment, the human profile comprises visual information that allows for the rendering of an avatar of the first human worker that can overlay the appearance of a humanoid robot.

In an embodiment, the human profile can be selected by the second human from a plurality of human profiles, wherein each of the plurality of human profiles is associated with a human. For example, for a humanoid robot that is a worker in a work environment, the plurality of human profiles can comprise human profiles associated with human workers of the work environment.

In an embodiment, the humanoid robot can appear as the first human from the perspectives of a plurality of humans. For example, a group of four humans can interact with a humanoid robot. Each person of the group of four humans can look at the humanoid robot through augmented reality glasses and the humanoid robot can appear as the first human to all four humans.

The behavior component 112 can adapt the appearance of the humanoid robot based on the human profile associated with the first human, wherein the human profile comprises information related to social interaction characteristics of interactions between the first human and the second human. For example, the behavior component 112 can cause the appearance of the humanoid robot to reflect certain facial expressions or body language associated with the social interaction characteristics. For example, the behavior component can cause the appearance of the humanoid robot to smile when approaching a human coworker based on information of the human profile indicating that the first human typically approaches the second human in a friendly manner. The behavior component 112 can further control physical movements of the humanoid robot based on the human profile, wherein the human profile comprises mobility and activity patterns of the first human. For example, if the first human generally makes hand gestures while explaining a concept, the behavior component 112 can cause the humanoid worker to mimic such hand gestures while explaining a concept to a human worker.

The various devices (e.g., system 100) and components (memory 104, processor 106, visualization component 110, and/or other components) of system 100 can be connected either directly or via one or more networks. Such networks can include wired and wireless networks, including, but not limited to, a cellular network, a wide area network (WAN) (e.g., the Internet), or a local area network (LAN), non-limiting examples of which include cellular, WAN, wireless fidelity (Wi-Fi), Wi-Max, WLAN, radio communication, microwave communication, satellite communication, optical communication, sonic communication, or any other suitable communication technology.

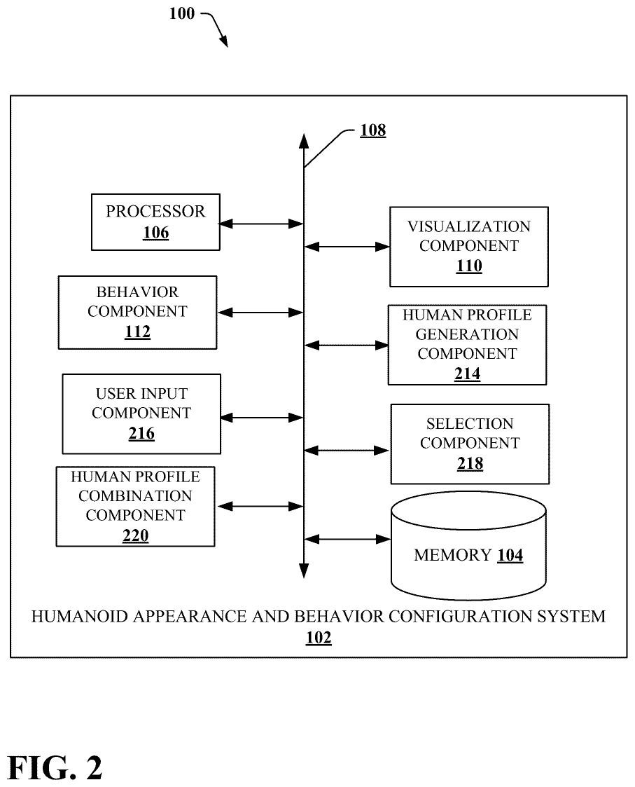

FIG. 2 illustrates a block diagram of an example, non-limiting system 200 that facilitates configuration of an appearance and behavior of a humanoid for interaction with a human in accordance with one or more embodiments described herein. Repetitive description of like elements and/or processes employed in respective embodiments is omitted for sake of brevity. As indicated previously, description relative to an embodiment of FIG. 1 can be applicable to an embodiment of FIG. 2. Likewise, description relative to an embodiment of FIG. 2 can be applicable to an embodiment of FIG. 1.

The system 200 comprises a human profile generation component 214. The human profile component 214 can generate a human profile associated with a human based on a knowledge corpus. In an embodiment, the knowledge corpus comprises information related to different types of social behavior, physical appearances and expressions, mobility and activity patterns, and social interactions. The information can be generally applicable social interaction and behavior data or may be specific to particular humans and/or relationships between particular humans. For example, the information can indicate that it is a general social rule to not speak at an unnecessarily loud volume. For another example, the information can indicate that a particular human who is a floor supervisor leads interactions with a particular floor associate regarding certain work tasks and takes direction from a particular floor manager regarding certain work tasks. For example, if the first human is the floor supervisor, the humanoid robot will adopt the behavioral and social characteristics specific to the first human, and when the humanoid robot interacts with the particular floor associate (i.e., the second human), the humanoid robot can behave as the first human typically does when interacting with the floor associate. In an embodiment, the human profile generation component 214 can generate human profiles based on use of one or more machine learning techniques. In an embodiment, the knowledge corpus and the human profiles can be continuously updated. In an embodiment, the knowledge corpus can receive information as user input and/or monitoring information.

The system 200 comprises a user input component 216. The user input component 216 can comprise a user interface. The user input component 216 can receive, for example, a selection of one or more human profiles to be applied to a humanoid robot via the visualization component 110 and the behavior component 112. The user input component 216 can further receive information for a knowledge corpus.

The selection component 218 can select a human profile from a plurality of human profiles based on the social interaction characteristics of the human profile and an identity of the second human. For example, a humanoid worker may be working on a shift with a particular second human. The selection component 218 can analyze available human profiles. The analysis of the human profiles can comprise an analysis of the relationships between the second human and the second human's various coworkers according to relationship information of the human profiles of the plurality of human coworkers. The selection component 218 can select a human profile of a first human of the human coworkers based on one or more metrics of the relationship between the first human and the second human. For example, if the selection component determines that the second worker is most productive when the second worker is working with a first human A, the selection component can select the human profile associated with the first human A to be applied to the humanoid robot.

The selection component 218 can further select a human profile to be applied to a humanoid robot that is to interact with a group of humans. In an embodiment, the selection component 218 can select a single human profile based on selections of human profiles of two or more members of the group of humans. In another embodiment, the selection component 218 can select the human profile based on the identities of the members of the group of humans. In an embodiment, the selection of the human profile can be based at least in part on the current or planned application of particular human profiles to other humanoid robots in the human-humanoid robot interaction environment.

The human profile combination component 220 can combine two or more human profiles of a plurality of human profiles to generate a combined human profile and the human profile can be the combined human profile. For example, a combined human profile can correspond to two or more humans. The combined human profile can comprise information related to the two or more humans and may cause the visualization component 110 to project an appearance having visual features of both or all of the two or more humans. The combined human profile can further cause the behavior component 112 to cause the humanoid robot to exhibit social characteristics of both or all of the two or more humans. For example, the behavior component 112 may cause the humanoid robot to exhibit the social characteristics of the second human and the mobility patterns of a third human.

In an embodiment, the two or more human profiles combined to generate the combined human profile can be human profiles selected by the user. In another embodiment, the two or more human profiles combined to generate the combined human profile can be human profiles selected by the selection component 218.

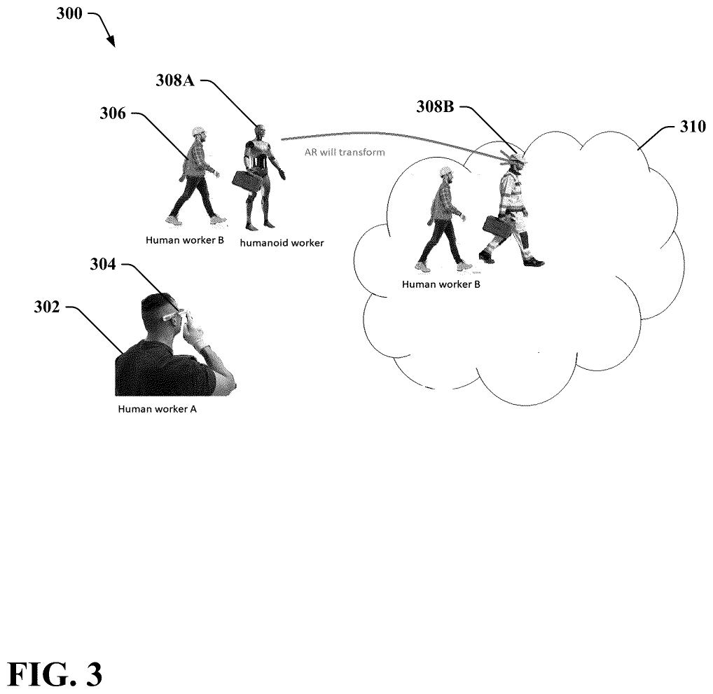

FIG. 3 illustrates an example, non-limiting system 300 that facilitates configuration of an appearance and behavior of a humanoid for interaction with a human, in accordance with one or more embodiments described herein. Repetitive description of like elements and/or processes employed in respective embodiments is omitted for sake of brevity. As indicated previously, description relative to an embodiment of FIGS. 1-2 can be applicable to an embodiment of FIG. 3. Likewise, description relative to an embodiment of FIG. 3 can be applicable to an embodiment of FIGS. 1-2.

The system 300 illustrates human worker A 302 (e.g., the second human) utilizing augmented reality technology 304 (e.g., visualization component 110). The human worker A 302 can look in the direction of human worker B 306 and a humanoid robot 308A. The augmented reality technology 304 can cause the perception of the human worker A 302 to be field of view 310. The augmented reality technology 404 can cause the humanoid robot 308B to have a human appearance and will not alter the appearance of human worker B 306. In an embodiment, the humanoid robot 308B appears to be a human coworker of human worker A and human worker B.

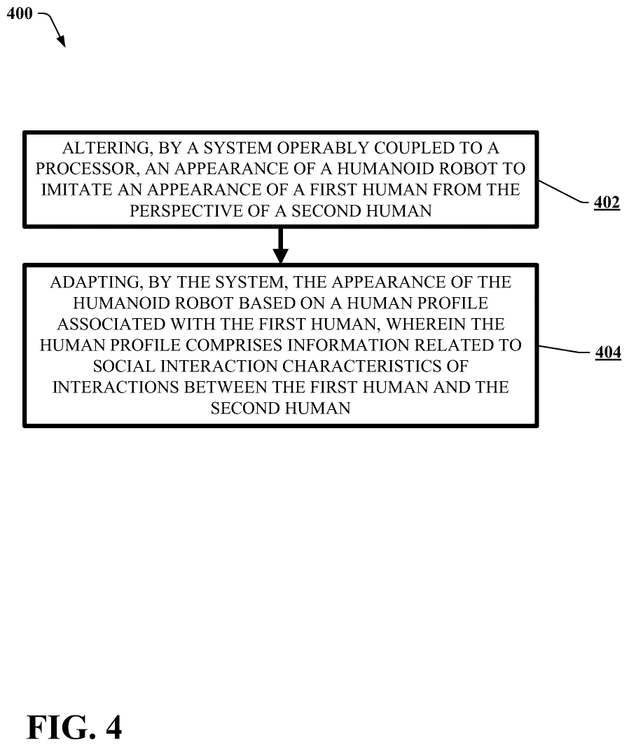

FIG. 4 illustrates a flow diagram of an example, non-limiting method 400 that can facilitate configuration of an appearance and a social behavior of a humanoid robot, such as in the non-limiting system 100 of FIG. 1. While the non-limiting method 400 is described relative to the non-limiting system 100 of FIG. 1, the non-limiting method 400 can be applicable also to other systems described herein. Repetitive description of like elements and/or processes employed in respective embodiments is omitted for sake of brevity. At 402, the non-limiting method 400 can comprise altering, by a system operably coupled to a processor (e.g., visualization component 110), an appearance of a humanoid robot to imitate an appearance of a first human from the perspective of a second human. At 404, the non-limiting method 400 can comprise adapting, by the system (e.g., behavior component 112), the appearance of the humanoid robot based on a human profile associated with the first human, wherein the human profile comprises information related to social interaction characteristics of interactions between the first human and the second human.

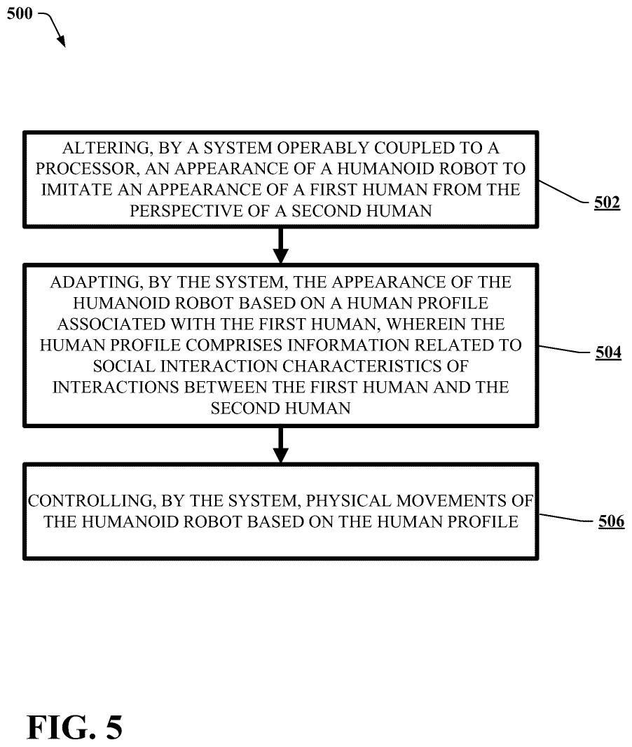

FIG. 5 illustrates a flow diagram of an example, non-limiting method 500 that can facilitate configuration of an appearance and a social behavior of a humanoid robot, such as in the non-limiting system 100 of FIG. 1. While the non-limiting method 500 is described relative to the non-limiting system 100 of FIG. 1, the non-limiting method 500 can be applicable also to other systems described herein. Repetitive description of like elements and/or processes employed in respective embodiments is omitted for sake of brevity. At 502, the non-limiting method 500 can comprise altering, by a system operably coupled to a processor (e.g., visualization component 110), an appearance of a humanoid robot to imitate an appearance of a first human from the perspective of a second human. At 504, the non-limiting method 500 can comprise adapting, by the system (e.g., behavior component 112), the appearance of the humanoid robot based on a human profile associated with the first human, wherein the human profile comprises information related to social interaction characteristics of interactions between the first human and the second human. At 506, the non-limiting method 500 can comprise controlling, by the system (e.g., behavior component 112), physical movements of the humanoid robot based on the human profile.

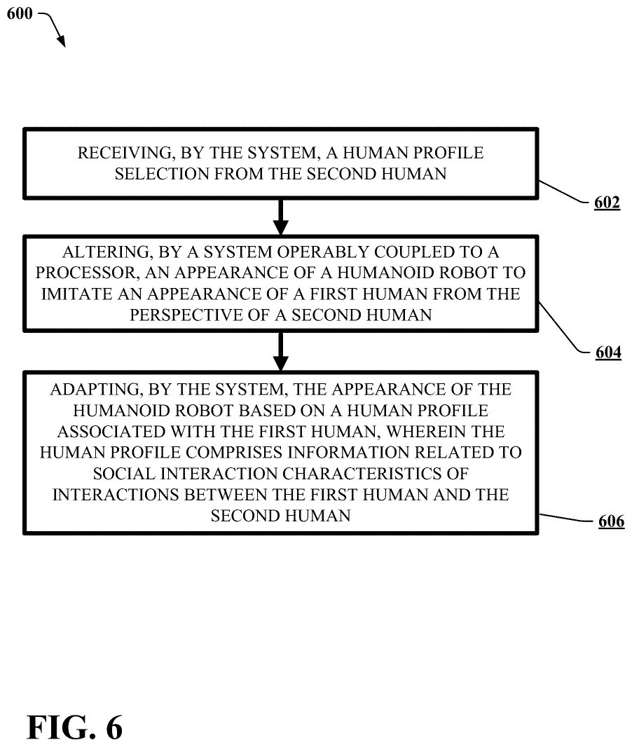

FIG. 6 illustrates a flow diagram of an example, non-limiting method 600 that can facilitate configuration of an appearance and a social behavior of a humanoid robot, such as in the non-limiting system 200 of FIG. 2. While the non-limiting method 600 is described relative to the non-limiting system 200 of FIG. 2, the non-limiting method 600 can be applicable also to other systems described herein. Repetitive description of like elements and/or processes employed in respective embodiments is omitted for sake of brevity. At 602, the non-limiting method 600 can comprise receiving, by the system (e.g., user input component 216), a human profile selection from the second human. At 604, the non-limiting method 600 can comprise altering, by a system operably coupled to a processor (e.g., visualization component 110), an appearance of a humanoid robot to imitate an appearance of a first human from the perspective of a second human. At 606, the non-limiting method 600 can comprise adapting, by the system (e.g., behavior component 112), the appearance of the humanoid robot based on a human profile associated with the first human, wherein the human profile comprises information related to social interaction characteristics of interactions between the first human and the second human.

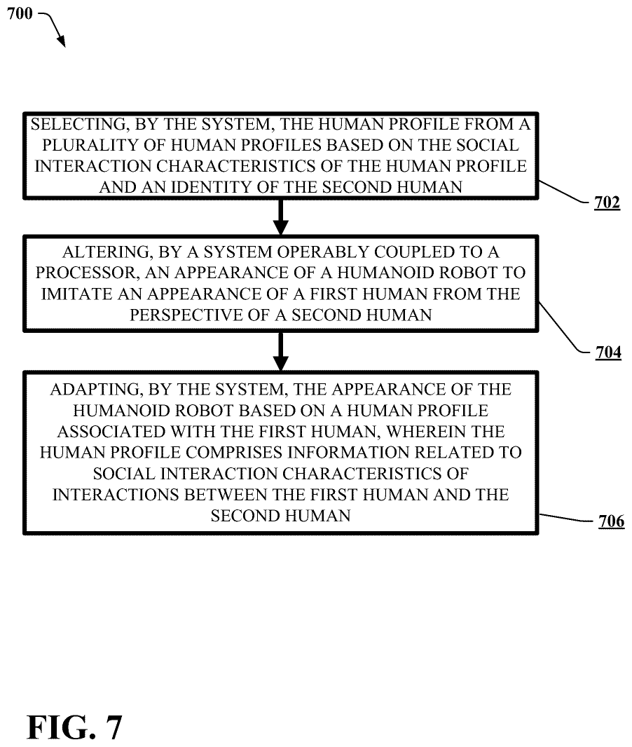

FIG. 7 illustrates a flow diagram of an example, non-limiting method 700 that can facilitate configuration of an appearance and a social behavior of a humanoid robot, such as in the non-limiting system 200 of FIG. 2. While the non-limiting method 700 is described relative to the non-limiting system 200 of FIG. 2, the non-limiting method 700 can be applicable also to other systems described herein. Repetitive description of like elements and/or processes employed in respective embodiments is omitted for sake of brevity. At 702, the non-limiting method 700 can comprise selecting, by the system (e.g., selection component 218), the human profile from a plurality of human profiles based on the social interaction characteristics of the human profile and an identity of the second human. At 704, the non-limiting method 700 can comprise altering, by a system operably coupled to a processor (e.g., visualization component 110), an appearance of a humanoid robot to imitate an appearance of a first human from the perspective of a second human. At 706, the non-limiting method 700 can comprise adapting, by the system (e.g., behavior component 112), the appearance of the humanoid robot based on a human profile associated with the first human, wherein the human profile comprises information related to social interaction characteristics of interactions between the first human and the second human.

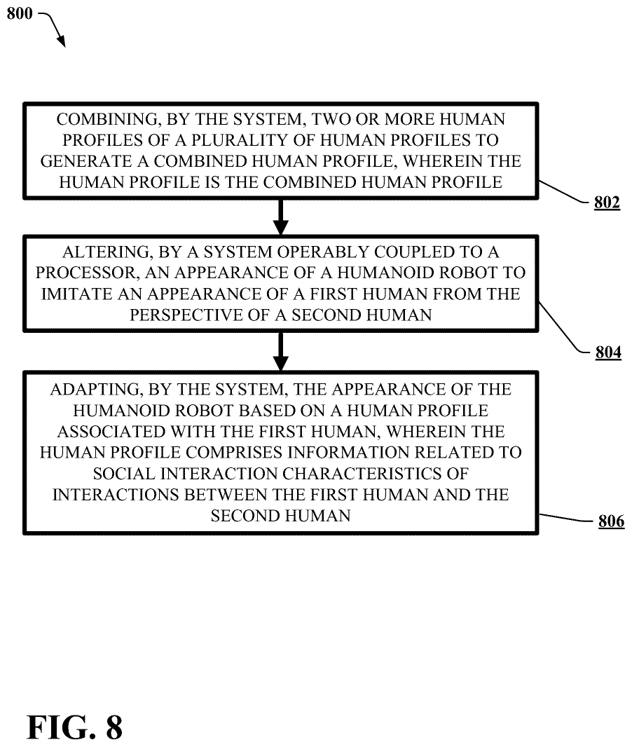

FIG. 8 illustrates a flow diagram of an example, non-limiting method 800 that can facilitate configuration of an appearance and a social behavior of a humanoid robot, such as in the non-limiting system 200 of FIG. 2. While the non-limiting method 800 is described relative to the non-limiting system 200 of FIG. 2, the non-limiting method 800 can be applicable also to other systems described herein. Repetitive description of like elements and/or processes employed in respective embodiments is omitted for sake of brevity. At 802, the non-limiting method 800 can comprise combining, by the system (e.g., human profile combination component 220), two or more human profiles of a plurality of human profiles to generate a combined human profile, wherein the human profile is the combined human profile. At 804, the non-limiting method 800 can comprise altering, by a system operably coupled to a processor (e.g., visualization component 110), an appearance of a humanoid robot to imitate an appearance of a first human from the perspective of a second human. At 806, the non-limiting method 800 can comprise adapting, by the system (e.g., behavior component 112), the appearance of the humanoid robot based on a human profile associated with the first human, wherein the human profile comprises information related to social interaction characteristics of interactions between the first human and the second human.

Turning next to FIG. 9, a detailed description is provided of additional context for the one or more embodiments described herein at FIGS. 1-8.

FIG. 9 and the following discussion are intended to provide a brief, general description of a suitable computing environment 1100 in which one or more embodiments described herein at FIGS. 1-8 can be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 900 contains an example of an environment for the execution of at least some of the computer code involved in performing the inventive methods, such as visualization and behavior code 945. In addition to block 945, computing environment 900 includes, for example, computer 901, wide area network (WAN) 902, end user device (EUD) 903, remote server 1104, public cloud 905, and private cloud 906. In this embodiment, computer 901 includes processor set 910 (including processing circuitry 920 and cache 921), communication fabric 911, volatile memory 912, persistent storage 913 (including operating system 922 and block 945, as identified above), peripheral device set 914 (including user interface (UI), device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 945 in persistent storage 913.

COMMUNICATION FABRIC 911 is the signal conduction paths that allow the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, the volatile memory is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface type operating systems that employ a kernel. The code included in block 945 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way. EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The embodiments described herein can be directed to one or more of a system, a method, an apparatus or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++ or the like, or procedural programming languages, such as the “C” programming language or similar programming languages. The computer readable program instructions can execute entirely on the user's computer, partly on the user's computer, as a stand-alone software package, partly on the user's computer or partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In one or more embodiments, electronic circuitry including, for example, programmable logic circuitry, field-programmable gate arrays (FPGA) or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described herein with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality, and operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function(s). In one or more alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that the one or more embodiments herein also can be implemented in combination with other program modules. Generally, program modules include routines, programs, components, data structures or the like that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics or the like. The illustrated aspects can also be practiced in distributed computing environments in which tasks are performed by remote processing devices that are linked through a communications network. However, some, if not all aspects of the one or more embodiments can be practiced on stand-alone computers. In a distributed computing environment, program modules can be located in both local and remote memory storage devices.

As used in this application, the terms “component,” “system,” “platform,” “interface,” or the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) or Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing the one or more embodiments, but one of ordinary skill in the art can recognize that many further combinations and permutations of the one or more embodiments are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the one or more embodiments provided herein have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a memory that stores computer executable components; and
a processor that executes computer executable components stored in the memory, wherein the computer executable components comprise:
a visualization component that alters an appearance of a humanoid robot to imitate an appearance of a first human from a perspective of a second human; and
a behavior component that adapts the appearance of the humanoid robot based on a human profile associated with the first human, wherein the human profile comprises information related to social interaction characteristics of interactions between the first human and the second human.

2. The system of claim 1, wherein the human profile further comprises mobility and activity patterns associated with the first human.

3. The system of claim 2, wherein the behavior component further controls physical movements of the humanoid robot based on the human profile.

4. The system of claim 1, wherein the second human selects the human profile from a plurality of human profiles.

5. The system of claim 1, wherein the visualization component alters the appearance of the humanoid robot via augmented reality.

6. The system of claim 1, wherein the computer executable components further comprise:
a selection component that selects the human profile from a plurality of human profiles based on the social interaction characteristics of the human profile and an identity of the second human.

7. The system of claim 1, wherein the computer executable components further comprise:
a human profile combination component that combines two or more human profiles of a plurality of human profiles to generate a combined human profile and wherein the human profile is the combined human profile.

8. The system of claim 7, wherein the second human selects the two or more human profiles of the plurality of human profiles.

9. A computer-implemented method, comprising:
altering, by a system operably coupled to a processor, an appearance of a humanoid robot to imitate an appearance of a first human from a perspective of a second human; and
adapting, by the system, the appearance of the humanoid robot based on a human profile associated with the first human, wherein the human profile comprises information related to social interaction characteristics of interactions between the first human and the second human.

10. The computer-implemented method of claim 9, wherein the human profile further comprises mobility and activity patterns associated with the first human.

11. The computer-implemented method of claim 10, further comprising:
controlling, by the system, physical movements of the humanoid robot based on the human profile.

12. The computer-implemented method of claim 9, further comprising:
receiving, by the system, a human profile selection from the second human.

13. The computer-implemented method of claim 9, further comprising:
selecting, by the system, the human profile from a plurality of human profiles based on the social interaction characteristics of the human profile and an identity of the second human.

14. The computer-implemented method of claim 9, further comprising:
combining, by the system, two or more human profiles of a plurality of human profiles to generate a combined human profile, wherein the human profile is the combined human profile.

15. A computer program product facilitating configuration of an appearance and a social behavior of a humanoid robot, the computer program product comprising a computer readable storage medium having program instructions embodied therewith, the program instructions executable by a processor to cause the processor to:
alter an appearance of a humanoid robot to imitate an appearance of a first human from a perspective of a second human; and
adapt the appearance of the humanoid robot based on a human profile associated with the first human, wherein the human profile comprises information related to social interaction characteristics of interactions between the first human and the second human.

16. The computer program product of claim 15, wherein the human profile further comprises mobility and activity patterns associated with the first human.

17. The computer program product of claim 16, wherein the program instructions are further executable by the processor to cause the processor to:
control physical movements of the humanoid robot based on the human profile.

18. The computer program product of claim 15, wherein the program instructions are further executable by the processor to cause the processor to:
receive a human profile selection from the second human.

19. The computer program product of claim 15, wherein the program instructions are further executable by the processor to cause the processor to:
select the human profile from a plurality of human profiles based on the social interaction characteristics of the human profile and an identity of the second human.

20. The computer program product of claim 15, wherein the program instructions are further executable by the processor to cause the processor to:
combine two or more human profiles of a plurality of human profiles to generate a combined human profile, wherein the human profile is the combined human profile.
